(19) United States
(12) Patent Application Publication
(10) Pub. No.: US 2026/0225631 A1
(43) Pub. Date: Aug. 6, 2026

(54) RAILWAY TRAIN-GROUND INTERCONNECTED PERCEPTION AND EARLY WARNING METHOD

(71) Applicant: CASCO SIGNAL LTD., Shanghai (CN)

(72) Inventors: Qingwen JIA, Shanghai (CN); Yina LUO, Shanghai (CN); Wei ZHAO, Shanghai (CN); Jiajia CHENG, Shanghai (CN)

(21) Appl. No.: 19/634,904

(22) Filed: Mar. 31, 2026

Related U.S. Application Data
(63) Continuation of application No. PCT/CN2024/131293, filed on Nov. 11, 2024.

(30) Foreign Application Priority Data
Oct. 11, 2024 (CN) 202411416565.8

(51) Int. Cl. B61L 23/06; B61L 25/02; G06V 20/54; H04N 7/18; H04N 23/90

(52) U.S. Cl. CPC B61L 23/06; B61L 25/025; G06V 20/54; H04N 7/181; H04N 23/90; B61L 2205/04

(57) ABSTRACT

The present disclosure provides a railway train-ground interconnected perception and early warning method, including: modeling a coverage area of a wayside camera of a track line; acquiring camera video information of an area in front of a train head from the modeling data of the coverage area of the wayside camera based on a train head position, and establishing a forward camera identifier list; retrieving corresponding video surveillance feeds based on camera identifiers in the forward camera identifier list, identifying an area with personnel on the track, and pushing camera information of a corresponding area to a corresponding locomotive on-board terminal and ground monitoring terminal; and receiving the camera information by the locomotive on-board terminal and the ground monitoring terminal, and issuing an early warning alert.

### CROSS-REFERENCE TO RELATED APPLICATIONS

This application is a Continuation Application of International Patent Application No. PCT/CN2024/131293, filed on November 11, 2024, which is based on and claims priority to and benefits of Chinese Patent Application No. 202411416565.8, filed with the China National Intellectual Property Administration on October 11, 2024. The above-referenced applications are incorporated herein by reference in their entirety.

### TECHNICAL FIELD

The present disclosure relates to the technical field of railway information, particularly to a railway train-ground interconnected perception and early warning method.

### BACKGROUND

To guarantee the safety of railway track operations, various protection and early warning systems are used for railway sites at present. The adopted technical routes are mainly divided into two categories: the first category is a safety protection and early warning system designed for railway construction or inspection operations in which personnel on the track are equipped with positioning and early warning terminals to monitor the position status of personnel in real time so as to issue an early warning alert when a train is approaching to notify relevant personnel to leave the track and take an evasive action; and the second category is that ground monitoring personnel know a locomotive travel position by means of a sensing device such as a camera or a radar, issue the early warning alert to relevant personnel when an approaching train is detected, or the sensing device is installed on the train head so that the early warning alert is issued to a driver when dangers are detected ahead.

For the first category of technical route, its limitation lies in the fact that it can only issue the early warning alert to personnel equipped with the positioning and early warning terminal within the railway system, while the safety status of other personnel cannot be guaranteed. For the second category of technical route, it can compensate for the shortcomings of the former, however, the existing technical solution fails to achieve the interconnection and sharing of video information such as positions and statuses of ground personnel on the track and the locomotive, consequently, the locomotive and personnel in close proximity cannot ascertain each other’s specific status through sensory information like videos, for example, the driver cannot know whether ground personnel have already left the track to take the evasive action, which hinders the personnel from making a timely and effective judgment, and therefore poses certain safety risks.

The statement herein only provides background art related to the present disclosure, and does not necessarily constitute the existing technologies.

### SUMMARY

In view of this, the objective of the present disclosure is to provide a railway train-ground interconnected perception and early warning method, so as to establish a timely and effective information interconnection and sharing channel between a locomotive driver and personnel on the track to realize the timely, accurate and effective transmission of early warning information when a train is approaching, thereby guaranteeing operation safety.

To realize the above objective, the present disclosure provides a railway train-ground interconnected perception and early warning method, including the following steps:

S1, modeling a coverage area of a wayside camera of a track line;

S2, acquiring camera video information of an area in front of a train head from the modeling data of the coverage area of the wayside camera based on a train head position, and establishing a forward camera identifier list;

S3, retrieving corresponding video surveillance feeds based on camera identifiers in the forward camera identifier list, identifying an area with personnel on the track, and pushing camera information of corresponding areas to a corresponding locomotive on-board terminal and ground monitoring terminal; and

S4, receiving the camera information by the locomotive on-board terminal and the ground monitoring terminal, and issuing an early warning alert.

Preferably, step S1 includes the following steps:

S11, acquiring a satellite positioning electronic map of track lines, modeling the horizontal coverage range of each wayside camera in the form of a polygon to obtain the default coverage range of each camera;

S12, setting a default orientation of each camera, and incorporating the default orientation into basic modeling data for management;

S13, initiating an early warning system, and calculating coordinates of intersection points between the default coverage range of each of the cameras and the track line by a background early warning server, thereby obtaining all the track areas of each camera; and

S14, traversing all cameras in the electronic map to obtain modeling data of the coverage area of the wayside camera corresponding to each track.

Preferably, in step S11, the horizontal coverage range of each of the wayside cameras is modeled in the form of a triangle.

Preferably, step S2 includes the following steps:

S21, acquiring a train head position by the background early warning server based on different traction and pushing modes of a locomotive; and

S22, searching the identifiers of all the cameras within the safety distance S on the route ahead of the train head based on the modeling data of the coverage area of the wayside camera in combination with interlocking code bit information acquired from a centralized traffic control system (CTC), and storing the searched identifiers into the forward camera identifier list of the train head.

Preferably, the safety distance S is determined based on an emergency braking distance, a train speed and a personnel reaction time lead.

Preferably, in step S21, a locomotive head position is used as the train head position if the current consist is in a locomotive traction mode; and a consist head position calculated by a shunting train protection system (STP) is used as the train head position if the current consist is in a locomotive pushing mode.

Preferably, when the consist is in a locomotive traction mode, if the locomotive is in a shunting surveillance mode, the position of the consist head on the track calculated by STP is the train head position; and if the locomotive is not in a shunting surveillance mode, a train head position calculated based on satellite positioning is used as the train head position.

Preferably, in step S22, whether the first camera closest to the train head position can be retained is determined based on the forward camera identifier list: when the default orientation of the first camera closest to the train head position is the same as a train running direction, the background early warning server removes the camera from the forward camera identifier list; and when the default orientation of the first camera closest to the train head position is opposite to the train running direction, the camera is retained in the forward camera identifier list.

Preferably, after step S22, the method further includes: when a camera in the forward camera identifier list is rotated, the background early warning server acquires a rotation angle from a video surveillance system and updates the coverage range of the rotated camera.

Preferably, if the coverage range of the rotated camera in the forward camera identifier list is unable to cover the route area ahead of the running train, the camera is deleted from the forward camera identifier list, thereby enhancing the flexibility and availability of the method.

Preferably, in step S3, the area with personnel on the track is identified based on an image recognition algorithm, thereby saving labor costs while improving the timeliness of early warning information transmission.

Preferably, in step S4, upon receiving the camera information, the locomotive on-board terminal plays the video surveillance feed of the nearest area with personnel on the track ahead in real time, and issues an early warning alert to a driver; and upon receiving the camera information, the ground monitoring terminal immediately issues the early warning alert to notify the personnel on the track in the corresponding area to leave the track in a timely manner and remind the personnel to watch out for and avoid oncoming trains.

Compared with the prior art, the technical solution of the present disclosure has the following advantages and benefits:

In the railway train-ground interconnected perception and early warning method of the present disclosure, the forward camera identifier list is established by modeling the coverage area of the wayside camera of the rail line; based on the camera identifiers listed in the forward camera identifier list, the corresponding video surveillance feeds are retrieved, areas with personnel on the track are identified, and then the camera information of the corresponding areas is then pushed to the corresponding locomotive on-board terminal and ground monitoring terminal to issue the early warning alert; and the timely and effective information interconnection and sharing channel is established between the locomotive driver and personnel on the track to realize the timely, accurate and effective transmission of early warning information when the train is approaching, thereby guaranteeing operation safety;

this solution integrates a track geographic information electronic map with monitoring coverage areas of wayside cameras, thereby enriching functional application scenarios and enhancing the expandability of the system; this solution comprehensively utilizes multi-source information such as STP, CTC and satellite positioning while considering two operation states such as traction and pushing, thereby improving the accuracy of positioning results; furthermore, both shunting and train modes are integrated, thereby expanding the scope of application of the system;

this solution enhances the interconnection among locomotive drivers, personnel on the tracks and ground monitoring personnel; the transmission of live video surveillance feeds to all parties improves the accuracy of early warning information, helps personnel involved in railway field operations to acquire potential safety risks in advance, and more effectively adopts countermeasures to prevent accidents; and

The existing system information is integrated by using this solution, thereby facilitating unified management and offering high maintainability; furthermore, updating and modification can be made to this solution based on the existing railway systems such as STP, CTC and video surveillance, with low modification costs.

### BRIEF DESCRIPTION OF THE DRAWINGS

FIG. 1 is a flowchart of a railway train-ground interconnected perception and early warning method according to the present disclosure;

FIG. 2 is a schematic diagram showing the modeling of a coverage area of a wayside camera in an embodiment of the present disclosure; and

FIG. 3 is a graph showing a relationship between a camera orientation and a train running direction in an embodiment of the present disclosure.

### DETAILED DESCRIPTION OF THE EMBODIMENTS

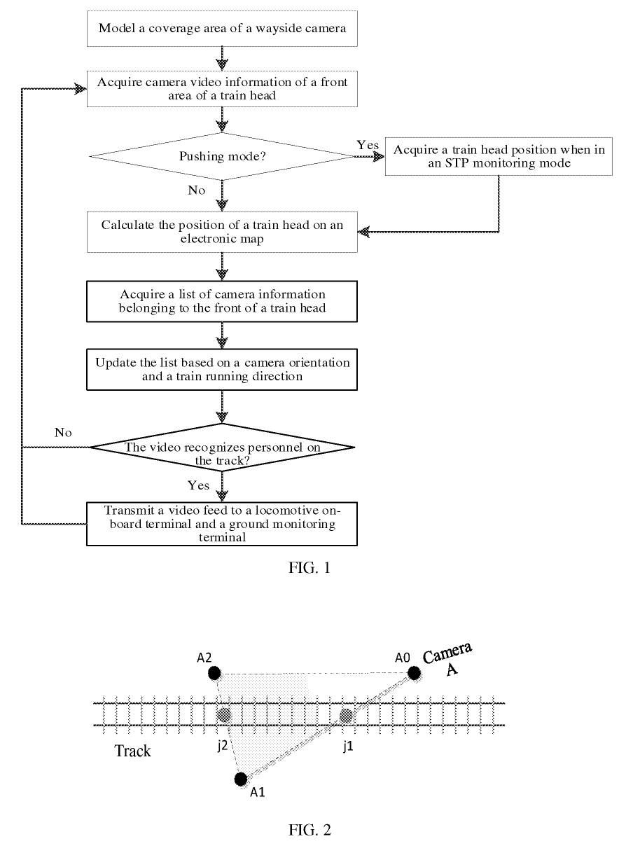

Next, the technical solution, configuration features, achieved purposes and effects in embodiments of the present disclosure will be described in detail with reference to FIG. 1-FIG. 3 in embodiments of the present disclosure.

It should be noted that the accompanying drawings adopt a very simplified form and all use inaccurate proportions, which are only used to assist in describing the implementation of the present disclosure conveniently and clearly and are not intended to limit the implementation conditions of the present disclosure. Therefore, it has no technical substantive significance. Any structural modification, change of a scale relationship or adjustment of size should still fall within the scope which can be covered by the technical content disclosed by the present disclosure without affecting the effects and the objective achieved by the present disclosure.

It should be noted that in this specification, relational terms such as first and second are only used to differentiate one entity or operation from another entity or operation, and do not necessarily require or imply that any actual relation or sequence exists between these entities or operations. Furthermore, the terms “include”, “comprise” or any other variants thereof are intended to cover non-exclusive inclusion, so that a process, method, article or device including a series of elements not only includes elements explicitly listed, but further includes other elements not explicitly listed, or also includes elements inherent to such process, method, article or device.

As described in the background, the current railway protection and early warning systems have safety hazards and limitations. To address the problem, the present disclosure proposes a video-based railway train-ground interconnected perception and early warning method. Based on an on-board and personnel positioning and early warning device, a ground monitoring terminal device and a video surveillance and recognition device in combination with STP (shunting protection system), CTC (centralized traffic control) and a track line electronic map, a multi-system information interconnection mechanism is established, so that locomotive drivers can acquire the operation status of personnel ahead in real time, and meanwhile ground monitoring personnel can also monitor the specific video feeds of locomotives close to personnel on the track and personnel on the track in real time.

As shown in FIG. 1, a railway train-ground interconnected perception and early warning method in this embodiment includes the following steps:

S1, a coverage area of a wayside camera of a track line is modeled, wherein step S1 specifically includes the following steps:

S11, a satellite positioning electronic map of track lines corresponding to a track line is acquired, and then the horizontal coverage range of each wayside camera in the form of a polygon is modeled to obtain the default coverage range of each camera;

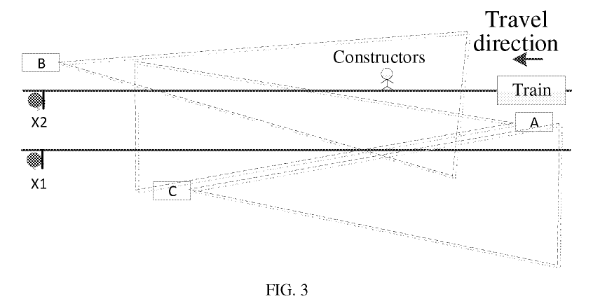

In this embodiment, modeling is performed in the form of a triangle; as shown in FIG. 2, the erecting position of each camera is used as an origin, the horizontal coverage range of its triangle is marked in the electronic map, the coordinates of each vertex of the triangle are stored in sequence, and the coordinates [A0, A1, A2] of three vertices of the coverage range of each camera constitute its default coverage range;

S12, a default orientation of each camera is set, and the default orientation is incorporated into basic modeling data for management;

S13, an early warning system is initiated, and coordinates [j1, j2,…, jn] of intersection points between the default coverage range of each of the cameras and the track line are calculated by a background early warning server, thereby obtaining all the track areas of each camera; and all the track areas covered by camera A in FIG. 2 range from j1 to j2; and

S14, all cameras in an electronic map are traversed to obtain the modeling data of the coverage area of the wayside camera corresponding to each track;

S2, camera video information of an area in front of a train head is acquired from the modeling data of the coverage area of the wayside camera based on a train head position, and a forward camera identifier list CameraList is established; and the step S2 specifically includes the following steps:

S21, a background early warning server acquires the train head position based on different traction and pushing modes of a locomotive, which is specifically as follows:

a locomotive head position is used as the train head position if the current consist is in a locomotive traction mode; wherein, the position L (stp) of a consist head on the track calculated by STP is used as the train head position if the locomotive is in a shunting surveillance mode; and a train head position L (gnss) calculated based on satellite positioning is used as the train head position if the locomotive is not in a shunting surveillance mode.

The locomotive is in a rear position if the current consist is in a locomotive pushing mode, at this moment, the consist head position L (stp) calculated by STP is used as the train head position.

S22, the identifiers of all the cameras within the safety distance S on the route ahead of the train head are searched based on the modeling data of the coverage area of the wayside camera in combination with interlocking code bit information acquired from a CTC system, and the searched identifiers are stored into the forward camera identifier list CameraList corresponding to the train head; wherein, the safety distance S is determined based on an emergency braking distance, a train speed and a personnel reaction time lead, and the personnel reaction time lead is preferably more than 150 s.

In step S22, whether the first camera closest to the train head position can be retained is determined based on the established forward camera identifier list CameraList: since the camera has a “blind spot under the light” (the vertical viewing angle of the camera is limited, resulting in an uncovered area within a certain radial distance from the camera), when the default orientation of the first camera closest to the train head position is the same as the train running direction, the background early warning server removes the camera from the forward camera identifier list CameraList; when the default orientation of the first camera closest to the train head position is opposite to the train running direction, the camera is retained in the forward camera identifier list CameraList; wherein, the default orientation of the camera is acquired from the basic modeling data in the modeling data of the coverage area of the wayside camera. FIG. 3 is a graph showing a relationship between a camera orientation and a train running direction. In this figure, the orientation of camera A is the same as the train running direction, and the orientations of cameras B and C are opposite to the train running direction.

S23, when a camera in the forward camera identifier list CameraList is rotated, the background early warning server acquires a rotation angle from a video surveillance system and updates the coverage range of the rotated camera; further, if the coverage range of the rotated camera is unable to cover the route area ahead of the running train, the camera is deleted from the forward camera identifier list CameraList;

S3, corresponding video surveillance feeds are retrieved based on camera identifiers in the forward camera identifier list, areas with personnel on the track are identified, and camera information of corresponding areas is pushed to a corresponding locomotive on-board terminal and ground monitoring terminal;

S4, the locomotive on-board terminal and the ground monitoring terminal receive the camera information, and issue an early warning alert;

upon receiving the camera information within the safety distance S ahead, the locomotive on-board terminal plays the video surveillance feed of the nearest area with personnel on the track ahead in real time and issues an early warning alert to a driver, and meanwhile the driver can select and switch to video feeds of other cameras within the modeling range; and

the background early warning server transmits camera information corresponding to an area with personnel on the track and a corresponding locomotive position to the ground monitoring terminal, and the ground monitoring terminal immediately issues the early warning alert upon receiving the information to notify the personnel on the track in the corresponding area to leave the track in a timely manner and remind the personnel to watch out for and avoid oncoming trains.

By taking the situation in FIG. 3 as an example, the actual application situation of the method of the present disclosure is explained. FIG. 3 illustrates the modeling of the coverage ranges of Cameras A, B and C in the electronic map. As the train travels leftward along the track from behind Camera A, all cameras (A and B) located within the safety distance S on the route ahead of the locomotive are identified and stored in the forward camera identifier list CameraList; it is determined that the orientation of the nearest camera (Camera A) is the same as the train running direction; consequently, it is removed from the forward camera identifier list CameraList. The video surveillance feed of Camera B is then retrieved. Based on an image recognition algorithm, it is identified that construction personnel are on the track within the coverage area of Camera B. Therefore, the information for Camera B is pushed to both the locomotive on-board terminal and the ground monitoring terminal. Upon receiving the video information, the on-board terminal pulls and plays the video stream while issuing an alert. Similarly, upon receiving the video information, the ground monitoring terminal pulls and plays the video stream and simultaneously notifies the on-track personnel to evacuate the track promptly.

The method of the present disclosure has been put into practical application and has also undergone implementation verification in a laboratory, demonstrating that the method can effectively safeguard railway traffic safety, reduce the labor costs associated with safety protection, and possess excellent implementability and economic benefits.

Although the contents of the present disclosure have been described in detail through preferred embodiments as described above, it should be understood that the above description shall not be construed as limiting the present disclosure. After those skilled in the art read the above contents, it will be obvious that multiple amendments and replacements can be made to the present disclosure. Therefore, the protective scope of the present disclosure shall be defined by appended claims.

1. A railway train-ground interconnected perception and early warning method, comprising the following steps:
S1, modeling a coverage area of a wayside camera of a track line;
S2, acquiring camera video information of an area in front of a train head from the modeling data of the coverage area of the wayside camera based on a train head position and establishing a forward camera identifier list;
S3, retrieving corresponding video surveillance feeds based on camera identifiers in the forward camera identifier list, identifying an area with personnel on the track, and pushing camera information of a corresponding area to a corresponding locomotive on-board terminal and ground monitoring terminal; and
S4, receiving the camera information by the locomotive on-board terminal and the ground monitoring terminal, and issuing an early warning alert.

2. The railway train-ground interconnected perception and early warning method according to claim 1, wherein step S1 comprises the following steps:
S11, acquiring a satellite positioning electronic map of track lines, modeling the horizontal coverage range of each wayside camera in the form of a polygon to obtain the default coverage range of each camera;
S12, setting a default orientation of each camera, and incorporating the default orientation into basic modeling data for management;
S13, initiating an early warning system, and calculating coordinates of intersection points between the default coverage range of each of the cameras and the track line by a background early warning server, thereby obtaining all track areas covered by each camera; and
S14, traversing all the cameras in the electronic map to obtain the modeling data of the coverage area of the wayside camera corresponding to each track.

3. The railway train-ground interconnected perception and early warning method according to claim 2, wherein in step S11, the horizontal coverage range of each of the wayside cameras is modeled in the form of a triangle.

4. The railway train-ground interconnected perception and early warning method according to claim 2, wherein step S2 comprises the following steps:
S21, acquiring a train head position by the background early warning server based on different traction and pushing modes of a locomotive; and
S22, searching the identifiers of all the cameras within the safety distance S on the route ahead of the train head based on the modeling data of the coverage area of the wayside camera in combination with interlocking code bit information acquired from a centralized traffic control system (CTC), and storing the searched identifiers into the forward camera identifier list corresponding to the train head.

5. The railway train-ground interconnected perception and early warning method according to claim 4, wherein the safety distance S is determined based on an emergency braking distance, a train speed and a personnel reaction time lead.

6. The railway train-ground interconnected perception and early warning method according to claim 4, wherein in step S21, a locomotive head position is used as the train head position if the current consist is in a locomotive traction mode; and a consist head position calculated by a shunting train protection system (STP) is used as the train head position if the current consist is in a locomotive pushing mode.

7. The railway train-ground interconnected perception and early warning method according to claim 6, wherein when the consist is in a locomotive traction mode, the position of a consist head on the track calculated by STP is the train head position if the locomotive is in a shunting surveillance mode; and a train head position calculated based on satellite positioning is used as the train head position if the locomotive is not in a shunting surveillance mode.

8. The railway train-ground interconnected perception and early warning method according to claim 4, wherein in step S22, for the forward camera identifier list, whether the first camera closest to the train head position is capable of being retained is determined: when the default orientation of the first camera closest to the train head position is the same as a train running direction, the background early warning server removes the camera from the forward camera identifier list; and when the default orientation of the first camera closest to the train head position is opposite to the train running direction, the camera is retained in the forward camera identifier list.

9. The railway train-ground interconnected perception and early warning method according to claim 4, wherein after step S22, the method further comprises: when a camera in the forward camera identifier list is rotated, the background early warning server acquires a rotation angle from a video surveillance system and updates the coverage range of the rotated camera.

10. The railway train-ground interconnected perception and early warning method according to claim 9, wherein if the coverage range of the rotated camera in the forward camera identifier list is unable to cover the route area ahead of the running train, the camera is deleted from the forward camera identifier list.

11. The railway train-ground interconnected perception and early warning method according to claim 1, wherein in step S3, the area with personnel on the track is identified based on an image recognition algorithm.

12. The railway train-ground interconnected perception and early warning method according to claim 1, wherein in step S4, upon receiving the camera information, the locomotive on-board terminal plays the video surveillance feed of the nearest area with personnel on the track ahead in real time, and issues an early warning alert to a driver; and
upon receiving the camera information, the ground monitoring terminal immediately issues the early warning alert to notify the personnel on the track in the corresponding area to leave the track in a timely manner and remind the personnel to watch out for and avoid approaching trains.
